(19) United States
(12) Patent Application Publication
(10) Pub. No.: US 2012/0254766 A1
(43) Pub. Date: Oct. 4, 2012

(54) METHOD TO EMBELLISH AN EXISTING RUI

(75) Inventors: Stephane Lejeune, San Diego, CA (US); Graham Clift, El Cajon, CA (US)

(73) Assignee: SONY CORPORATION, Tokyo (JP)

(21) Appl. No.: 13/073,788

(22) Filed: Mar. 28, 2011

(51) Int. Cl. G06F 3/01

(52) U.S. Cl. 715/740

(57) ABSTRACT

A method of embellishing a remote user interface includes utilizing metadata to complement the remote user interface. The metadata is able to be used by a device such as an intermediate device to generate additional information related to the remote user interface. The embellished remote user interface is then sent to a rendering device to be displayed and provide a user with an improved viewing experience.

### FIELD OF THE INVENTION

The present invention relates to the field of remote user interfaces. More specifically, the present invention relates to embellishing an existing remote user interface using an intermediate device.

### BACKGROUND OF THE INVENTION

The number of electronic devices in people's homes is continually increasing. Many years ago, homes only had a radio; then, a radio and a television. The number of devices has increased to the point where a typical home has several televisions, stereos, computers, video game consoles, mobile phones/devices, appliances and others. Furthermore, these devices are gaining intelligence so that they are able to communicate with each other.

The expansion of residential networks to include a multiplicity of devices that can share files asynchronously and connect to the Internet through residential gateways was facilitated by the de-facto standard use of wired and wireless ethernet connectivity. Asynchronous sharing then started to give way to buffered streaming of video as bandwidth availability improved. This was closely followed by real time streaming. Networks employ quality of service to manage bandwidth resource and Universal Plug and Play (UPnP) to perform discovery and compatibility of compressed video content. Video UPnP also defines remote user input operation like play, stop and rewind so that video control as well as video display is able to be performed remotely. Also, provisions were made to support graphical transfer of a remote user interface, but no implementations on the market have made use of this. UPnP allowed for many different standards of compressed video, but does not, however, certify that a client supported the relevant decoder. Digital Living Network Alliance (DLNA) is a standards body formed to provide certified device compatibility for a specific subset of UPnP implementations. It also defined the role of media servers, renderers, adapters, players and controllers.

A standard, referred to as Remote User Interface (RUI or Remote UI) is being developed to allow devices to operate each other and provide the user with a user interface that is configured appropriately for a device being used to control another device. For example, a user interface for a 46″ wide television is not likely to appear properly on a mobile phone which has a display of 2″. The Remote UI standard is a web-based protocol and framework for remote user interface on UPnP Networks and the Internet. The standard allows a UPnP-capable home network device to provide its interface (display and control options) as a web page to display on any other device coupled to the home network.

There are no well defined and widely accepted UPnP implementations for graphical RUI. One option, which has been backed by the UPnP Forum, is a browser based implementation known as CEA2014. The network client browser is considered to be heavy in flash, memory and/or processor requirements (‘thick’ client), whereas the network server application performs simple encapsulation of XML (‘thin’ server). In some situations this may be acceptable, like the case when rendering is performed by a personal computer and the application is run on a small mobile device, or a low end processing device, like a network router.

However, in the case of the home network where the rendering is done by a high definition TV, a Blu-Ray® player, a picture frame or a gaming machine, the use of a browser for RUI has some disadvantages. Firstly, a browser adds to the already substantial memory requirements of the renderers and so for these cost sensitive consumer electronics devices it may not be viable. Secondly, the processing speed requirements for a responsive experience are not going to be provided by the current range of devices available. And thirdly, the browser interface lends itself well to mouse and keyboard control, but is not necessarily the ideal format for a limited button remote control.

Also, the home network is able to include graphics applications built into game machines, video players, dongles and intelligent remotes on the low end, with cable boxes, cloud servers and multimedia PCs on the high end. To shoehorn all of these into one UPnP standard, it is clear that reach will be limited. In some cases substantial effort of rewriting or translation of the graphics application might be needed in order to fit the browser framework.

Another example of a proposed RUI is being provided through the RVU alliance. The RVU alliance was initiated by DirectTV in order to provide a pixel accurate remotely rendered version of their satellite decoder user interface. Unlike the browser based RUI, RVU uses a low level protocol that manipulates the graphics card framebuffer layers more directly. Instead of the script type messages that CEA2014 uses, RVU breaks up elements of the graphics into images that can be sent compressed or uncompressed over the network to be composited in the renderer's screen buffers or off screen buffers as needed. Simple bit commands are sent over the network to allow the images to be stretched, cut and alpha-blended on the renderer side. This type of RUI would be considered a thin network client and thick network server because most of the computation effort would be with the application. Also, because most actions involve sending image data, this type of RUI uses a lot of network resources.

The advantage of RVU is that the low level graphics operations are able to be supported by all graphics cards quite easily and is not directly dependent on the type of application to be able to function. However, sometimes performance is a key parameter in usability, and as such the network load and network server performance could severely limit how useful the protocol is. RVU is especially vulnerable where complete screen refreshes are needed often, like 3D rotations of a view. A browser approach could handle this more simply through scripts of simple rotation commands. Another similar limitation is when the application is providing remote graphics to multiple renderers, and causes the application processor to run short of the necessary MIPS to perform adequately.

### SUMMARY OF THE INVENTION

A method of embellishing a remote user interface includes utilizing metadata to complement the remote user interface. The metadata is able to be used by a device such as an intermediate device to generate additional information related to the remote user interface. The embellished remote user interface is then sent to a rendering device to be displayed and provide a user with an improved viewing experience.

In one aspect, a method of embellishing a remote user interface comprises discovering an intermediate device, communicating remote user interface data and metadata between a source device and the intermediate device, processing the remote user interface data and the metadata into an embellished remote user interface on the intermediate device, communicating the embellished remote user interface to a rendering device and rendering the embellished remote user interface on the rendering device. Communicating between the source device and the intermediate device comprises the source device sending the remote user interface data and the metadata to the intermediate device. Communicating the embellished remote user interface to the rendering device comprises sending the embellished remote user interface data from the intermediate device to the rendering device. The intermediate device is discovered by the source device and the rendering device. The intermediate device comprises an implementation to utilize the metadata to generate the embellished remote user interface. The implementation to utilize the metadata comprises a website. The intermediate device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

In another aspect, a network of devices comprises an intermediate device for processing remote user interface data and metadata into an embellished remote user interface data, one or more source devices for sending the remote user interface data and the metadata to the intermediate device and one or more rendering devices for rendering the embellished remote user interface data received from the intermediate device. The intermediate device is discovered by the one or more source devices and the one or more rendering devices. The intermediate device comprises an implementation to utilize the metadata to generate the embellished remote user interface. The implementation to utilize the metadata comprises a website. The intermediate device, the one or more source devices and the one or more rendering devices are coupled through a network. The intermediate device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

In another aspect, a system programmed in a controller in a device comprises a processing module for processing remote user interface data and metadata and a communication module for communicating an embellished remote user interface to a renderer. The processing module further comprises an implementation to utilize the metadata to generate the embellished remote user interface. The implementation to utilize the metadata comprises a website. The embellished remote user interface includes the remote user interface and supplemental information related to the remote user interface. The device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

In yet another aspect, an intermediate device comprises a memory for storing an application, the application for processing remote user interface data and metadata into an embellished remote user interface, communicating the embellished remote user interface to a rendering device and a processing component coupled to the memory, the processing component for processing the application. The embellished remote user interface includes the remote user interface and supplemental information related to the remote user interface.

### BRIEF DESCRIPTION OF THE DRAWINGS

FIG. 1 illustrates a block diagram of a network of devices implementing a method of embellishing an RUI according to some embodiments.

FIG. 2 illustrates a flowchart of a method of utilizing an intermediate device according to some embodiments.

FIG. 3 illustrates a block diagram of an exemplary computing device to embellish an RUI according to some embodiments.

### DETAILED DESCRIPTION OF THE PREFERRED EMBODIMENT

An intermediate device is able to be utilized in a home network to embellish an existing Remote User Interface (Remote UI or RUI). When a source device sends an RUI command, the source device also sends metadata. The metadata is able to be utilized by the intermediate device to generate additional information which is able to be displayed by a rendering device to embellish the RUI.

The RUI protocol is able to be extended to include a description stream associated with the UI generated and the RUI provided. The RUI rendering device receives the RUI and its associated description feed. The associated description feed is used with the other services accessible by the RUI renderer. The RUI renderer meshes the RUI with its own services based on the associated description feed.

FIG. 1 illustrates a block diagram of a network of devices implementing a method of embellishing an RUI according to some embodiments. The network of devices 100 includes one or more gateway or source devices 102 coupled to an intermediate device 104 which is coupled to a renderer (e.g. a television) 106. In some embodiments, the source device 102, the intermediate device 104 and the renderer 106 are coupled directly, and in some embodiments, the source device 102, the intermediate device 104 and the renderer 106 are coupled through a network. The network is able to be any type of network including, but not limited to, a LAN, a WAN, the Internet, a cellular network, a wireless network, a wired network and/or any combination thereof.

The source device 102 is any device that sends RUI data 108 such as commands to a renderer 106. In some embodiments, the RUI data 108 is sent to an intermediate device 104 which processes the RUI data 108 and then sends the processed data to the renderer 106. The source device 102 also sends metadata 110 to the intermediate device 104 which is used to enhance or embellish the RUI data 108. In some embodiments, the metadata 110 is sent from another device. In some embodiments, the metadata 110 is pre-stored on the intermediate device 104.

The intermediate device 104 is any device that is able to process the RUI data 108 and the metadata 110 which is used to enhance the RUI data 108. In some embodiments, the intermediate device 104 includes additional software, firmware and/or hardware to utilize and process the metadata 110. For example, the intermediate device 104 includes Google™ Maps which is able to utilize mapping metadata to provide additional information to the RUI data 108.

The renderer 106 is any device that is able to render and display the RUI data 108. In some embodiments, the RUI data 108 is processed along with metadata 110, and the renderer 106 displays the processed information.

In operation, the source device 102 sends RUI data 108 and metadata 110 to the intermediate device 104. The intermediate device 104 processes the RUI data 108 and the metadata 110. The metadata 110 is able to be used to embellish the RUI data 108. For example, the metadata 110 includes map information related to the RUI data 108. The intermediate device 104 then uses the map information and generates a map which is then incorporated with the RUI data 108. The intermediate device 104 then sends an embellished RUI 112 to the renderer 106 which is able to display the embellished RUI 112. For example, a video is displayed about a city, and a map of the city is also displayed.

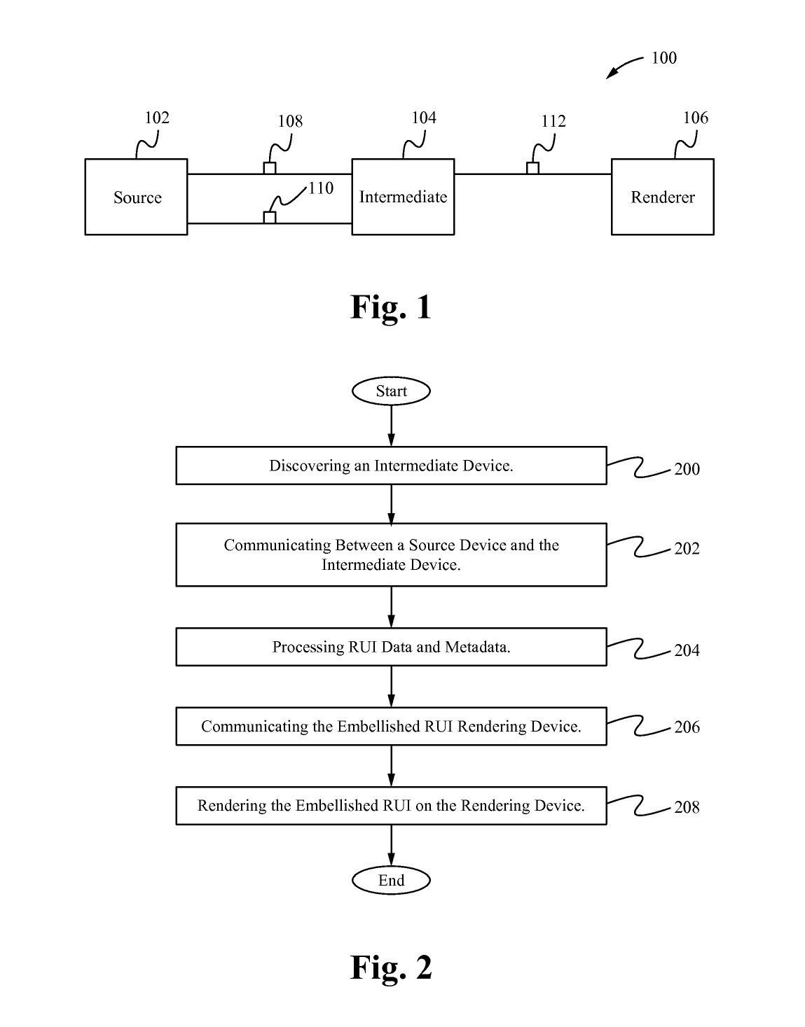

FIG. 2 illustrates a flowchart of a method of utilizing an intermediate device according to some embodiments. In the step 200, an intermediate device is discovered. The discovery of the intermediate device is by any of the devices such as the source device(s) and the renderer(s). In the step 202, a source device communicates with the intermediate device. The communication is able to include sending RUI data and metadata. The RUI data is able to be any form such as a file, a stream or any other data format. In the step 204, the intermediate device processes the RUI data and the metadata into an embellished RUI. Processing the RUI data and metadata is able to include any processing. An example of processing includes rendering the RUI data, processing the metadata and merging the result. As described above, processing the metadata is able to include using the metadata with a program or website (e.g. Google™ maps) to generate an embellished RUI. In the step 206, the intermediate device communicates (e.g. sends) the embellished RUI (e.g. processed RUI data and result from metadata combined) to a renderer. In the step 208, the renderer renders the embellished RUI (e.g. displays a video on a television with supplemental information from the metadata). In some embodiments, rendering includes simply displaying a video on a device, and in some embodiments, rendering includes further processing of a video and then displaying the video. Although specific steps are described, in some embodiments, fewer or more steps are included, and/or the order of the steps is able to be changed.

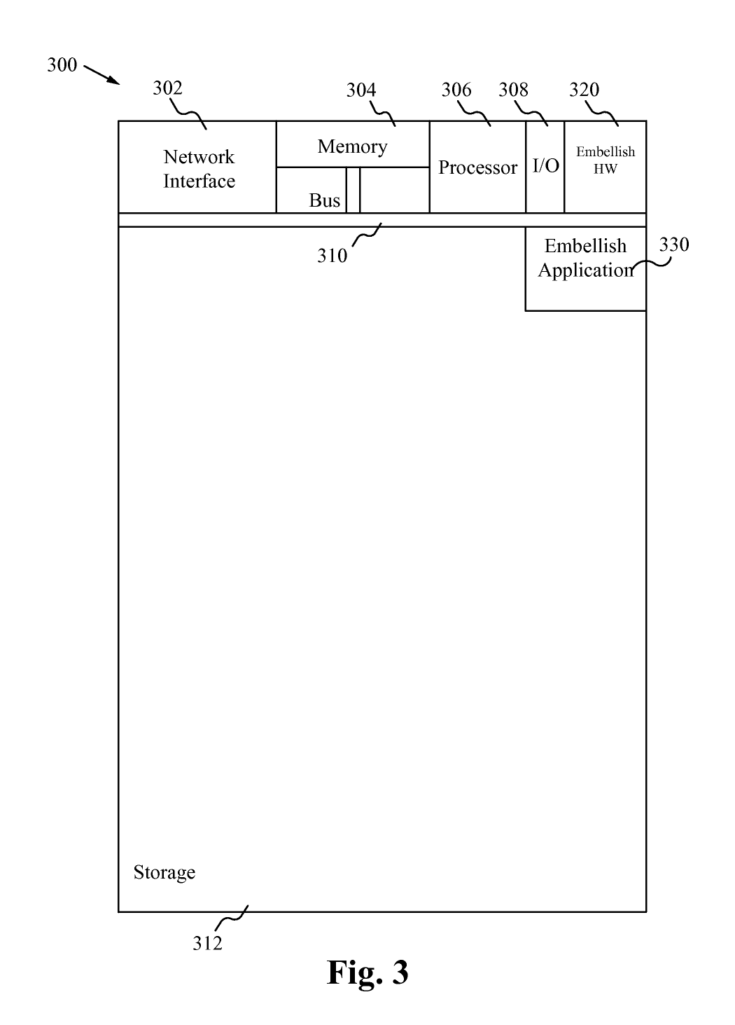

FIG. 3 illustrates a block diagram of an exemplary computing device 300 to generate an embellished RUI according to some embodiments. The computing device 300 is able to be used to acquire, store, compute, communicate and/or display information. For example, the computing device 300 is able to receive, generate, store, and embellish an RUI. The computing device 300 is also able to provide additional processing power and memory to assist in other devices' processing. In general, a hardware structure suitable for implementing the computing device 300 includes a network interface 302, a memory 304, a processor 306, I/O device(s) 308, a bus 310 and a storage device 312. The choice of processor is not critical as long as a suitable processor with sufficient speed is chosen. The memory 304 is able to be any conventional computer memory known in the art. The storage device 312 is able to include a hard drive, CDROM, CDRW, DVD, DVDRW, Blu-ray®, flash memory card or any other storage device. The computing device 300 is able to include one or more network interfaces 302. An example of a network interface includes a network card connected to an Ethernet or other type of LAN. The I/O device(s) 308 are able to include one or more of the following: keyboard, mouse, monitor, display, printer, modem, touchscreen, button interface and other devices. Embellishing application(s) 330 used to perform the RUI embellishment method are likely to be stored in the storage device 312 and memory 304 and processed as applications are typically processed. More or less components shown in FIG. 3 are able to be included in the computing device 300. In some embodiments, RUI embellishment method hardware 320 is included. Although the computing device 300 in FIG. 3 includes applications 330 and hardware 320, the RUI embellishment method is able to be implemented on a computing device in hardware, firmware, software or any combination thereof. For example, in some embodiments, the RUI embellishment method applications 330 are programmed in a memory and executed using a processor. In another example, in some embodiments, the RUI embellishment method hardware 320 is programmed hardware logic including gates specifically designed to implement the RUI embellishment method.

In some embodiments, the RUI embellishment method application(s) 330 include several applications and/or modules. As described herein, the modules are able to include a processing module for processing the RUI data and the metadata and a communication module for communicating an embellished RUI to a renderer. In some embodiments, modules include one or more sub-modules as well. In some embodiments, fewer or additional modules are able to be included.

Examples of suitable computing devices for the intermediate device, source device and rendering device include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone, a video player, a DVD writer/player, a Blu-ray® writer/player, a television, a home entertainment system or any other suitable computing device. In some embodiments, a computing device is able to include intelligent appliances such as a refrigerator, a toaster, a toaster oven and a microwave, where the appliances are able to process and/or present information.

To utilize the method of embellishing an RUI, a user incorporates an intermediate device between a source device and a renderer. When the user issues an RUI command, the intermediate device receives RUI data and metadata from the source device and processes the RUI data and the metadata. The metadata embellishes the RUI data, and the embellished RUI is sent to a rendering device. The embellishment occurs automatically and without user intervention. As a result, the user views the embellished RUI on the rendering device.

In operation, the method of embellishing an RUI, an intermediate device is implemented between a source device and a renderer. The intermediate device receives RUI data and metadata from the source device and processes the RUI data and the metadata. The metadata is used to embellish the RUI data. The embellished RUI is displayed on a rendering device such as a television. The embellished RUI provides a better user experience for the user. Examples of embellishment include, but are not limited to, adding a frame to an image/video, providing mapping information, providing pricing information and many other implementations.

The devices implemented within the network described herein are able to implement Digital Living Network Alliance (DLNA) standard as well.

### Some Embodiments of a Method to Embellish an Existing RUI

1. A method of embellishing a remote user interface comprising:
   a. discovering an intermediate device;
   b. communicating remote user interface data and metadata between a source device and the intermediate device;
   c. processing the remote user interface data and the metadata into an embellished remote user interface on the intermediate device;
   d. communicating the embellished remote user interface to a rendering device; and
   e. rendering the embellished remote user interface on the rendering device.
2. The method of clause 1 wherein communicating between the source device and the intermediate device comprises the source device sending the remote user interface data and the metadata to the intermediate device.
3. The method of clause 1 wherein communicating the embellished remote user interface to the rendering device comprises sending the embellished remote user interface data from the intermediate device to the rendering device.
4. The method of clause 1 wherein the intermediate device is discovered by the source device and the rendering device.
5. The method of clause 1 wherein the intermediate device comprises an implementation to utilize the metadata to generate the embellished remote user interface.
6. The method of clause 5 wherein the implementation to utilize the metadata comprises a website.
7. The method of clause 1 wherein the intermediate device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.
8. A network of devices comprising:
   a. an intermediate device for processing remote user interface data and metadata into an embellished remote user interface data;
   b. one or more source devices for sending the remote user interface data and the metadata to the intermediate device; and
   c. one or more rendering devices for rendering the embellished remote user interface data received from the intermediate device.
9. The network of devices of clause 8 wherein the intermediate device is discovered by the one or more source devices and the one or more rendering devices.
10. The network of devices of clause 8 wherein the intermediate device comprises an implementation to utilize the metadata to generate the embellished remote user interface.
11. The network of devices of clause 10 wherein the implementation to utilize the metadata comprises a website.
12. The network of devices of clause 8 wherein the intermediate device, the one or more source devices and the one or more rendering devices are coupled through a network.
13. The network of devices of clause 8 wherein the intermediate device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.
14. A system programmed in a controller in a device comprising:
   a. a processing module for processing remote user interface data and metadata; and
   b. a communication module for communicating an embellished remote user interface to a renderer.
15. The system of clause 14 wherein the processing module further comprises an implementation to utilize the metadata to generate the embellished remote user interface.
16. The system of clause 15 wherein the implementation to utilize the metadata comprises a website.
17. The system of clause 14 wherein the embellished remote user interface includes the remote user interface and supplemental information related to the remote user interface.
18. The system of clause 14 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.
19. An intermediate device comprising:
   a. a memory for storing an application, the application for:
      i. processing remote user interface data and metadata into an embellished remote user interface; and
      ii. communicating the embellished remote user interface to a rendering device; and
   b. a processing component coupled to the memory, the processing component for processing the application.
20. The device of clause 19 wherein the embellished remote user interface includes the remote user interface and supplemental information related to the remote user interface.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method of embellishing a remote user interface comprising:
a. discovering an intermediate device;
b. communicating remote user interface data and metadata between a source device and the intermediate device;
c. processing the remote user interface data and the metadata into an embellished remote user interface on the intermediate device;
d. communicating the embellished remote user interface to a rendering device; and
e. rendering the embellished remote user interface on the rendering device.

2. The method of claim 1 wherein communicating between the source device and the intermediate device comprises the source device sending the remote user interface data and the metadata to the intermediate device.

3. The method of claim 1 wherein communicating the embellished remote user interface to the rendering device comprises sending the embellished remote user interface data from the intermediate device to the rendering device.

4. The method of claim 1 wherein the intermediate device is discovered by the source device and the rendering device.

5. The method of claim 1 wherein the intermediate device comprises an implementation to utilize the metadata to generate the embellished remote user interface.

6. The method of claim 5 wherein the implementation to utilize the metadata comprises a website.

7. The method of claim 1 wherein the intermediate device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

8. A network of devices comprising:
a. an intermediate device for processing remote user interface data and metadata into an embellished remote user interface data;
b. one or more source devices for sending the remote user interface data and the metadata to the intermediate device; and
c. one or more rendering devices for rendering the embellished remote user interface data received from the intermediate device.

9. The network of devices of claim 8 wherein the intermediate device is discovered by the one or more source devices and the one or more rendering devices.

10. The network of devices of claim 8 wherein the intermediate device comprises an implementation to utilize the metadata to generate the embellished remote user interface.

11. The network of devices of claim 10 wherein the implementation to utilize the metadata comprises a website.

12. The network of devices of claim 8 wherein the intermediate device, the one or more source devices and the one or more rendering devices are coupled through a network.

13. The network of devices of claim 8 wherein the intermediate device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

14. A system programmed in a controller in a device comprising:
a. a processing module for processing remote user interface data and metadata; and
b. a communication module for communicating an embellished remote user interface to a renderer.

15. The system of claim 14 wherein the processing module further comprises an implementation to utilize the metadata to generate the embellished remote user interface.

16. The system of claim 15 wherein the implementation to utilize the metadata comprises a website.

17. The system of claim 14 wherein the embellished remote user interface includes the remote user interface and supplemental information related to the remote user interface.

18. The system of claim 14 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

19. An intermediate device comprising:
a. a memory for storing an application, the application for:
i. processing remote user interface data and metadata into an embellished remote user interface; and
ii. communicating the embellished remote user interface to a rendering device; and
b. a processing component coupled to the memory, the processing component for processing the application.

20. The device of claim 19 wherein the embellished remote user interface includes the remote user interface and supplemental information related to the remote user interface.
